(19) United States
(12) Patent Application Publication
(10) Pub. No.: US 2021/0173382 A1
(43) Pub. Date: Jun. 10, 2021

(54) CONTROL DEVICE AND RECORDING MEDIUM ENCODED WITH PROGRAM

(71) Applicant: FANUC CORPORATION, Yamanashi (JP)

(72) Inventor: Takuma NISHIMURA, Yamanashi (JP)

(73) Assignee: FANUC CORPORATION, Yamanashi (JP)

(21) Appl. No.: 16/951,054

(22) Filed: Nov. 18, 2020

(30) Foreign Application Priority Data
Dec. 9, 2019 (JP) 2019-222314

(51) Int. Cl. G05B 19/416

(52) U.S. Cl. CPC G05B 19/4163; G05B 2219/37611

(57) ABSTRACT

A control device which controls a machine tool so as to move a table during exchange of tools includes: a movement distance acquisition unit which acquires a movement distance of the table during tool exchange; a movement time calculation unit which calculates a fastest movement time from an acquired movement distance, and a speed at which the table is caused to move fastest; a tool exchange time calculation unit which calculates a tool exchange time; a comparison unit which compares the tool exchange time calculated with the fastest movement time calculated; and a speed changing unit which changes the movement speed of the table, in a case of the fastest movement time being shorter than the tool exchange time, so that the movement time of the table becomes longer than the fastest movement time.

This application is based on and claims the benefit of priority from Japanese Patent Application 2019-222314, filed on 9 Dec. 2019, the content of which is incorporated herein by reference.

BACKGROUND OF THE INVENTION

### Field of the Invention

The present disclosure relates to a control device and a recording medium encoded with a program.

### Related Art

Conventionally, a machine tool has been known which machines a workpiece placed on a table using a tool. In the machine tool, the tool and the table are moved to machine a workpiece into a predetermined shape. The control device controls the movement of the machine tool.

Shortening of the cycle time for machining is important for the machine tool. Therefore, the speed of the movement of the table, exchange of tools, etc. is often set so as to be the fastest. For example, a tool holder which shortens the tool exchange time has been proposed (for example, refer to Patent Document 1).

Patent Document 1: Japanese. Unexamined Utility Model Application, Publication No. S62-153029

### SUMMARY OF THE INVENTION

In relation to shortening of the cycle time, for example, it is useful to move the table in advance to the next machining position while exchanging tools. After exchanging tools, it is thereby possible to start machining of the workpiece immediately. On the other hand, rapid traversing the table at maximum speed may lead to heat generation of the motor. Since time is required to naturally cool the heat generation of the motor, it is desirable to avoid the heat generation. Therefore, it is suitable if possible to optimize the movement speed of the table during tool exchange.

A first aspect of the present disclosure relates to a control device which controls a machine tool so as to move a table during exchange of tools, the control device including: a movement distance acquisition unit which acquires a movement distance of the table during tool exchange; a movement time calculation unit which calculates a fastest movement time from an acquired movement distance, and a speed at which the table is caused to move fastest; a tool exchange time calculation unit which calculates a tool exchange time; a comparison unit which compares the tool exchange time calculated and the fastest movement time calculated; and a speed changing unit which changes the movement speed of the table, in a case of the fastest movement time being shorter than the tool exchange time, so that the movement time of the table becomes longer than the fastest movement time.

In addition, a second aspect of the present invention relates to a recording medium encoded with a program for causing a computer to function as a control device which controls a machine tool so as to move a table during exchange of tools, the program causing the computer to function as: a movement distance acquisition unit which acquires a movement distance of the table during tool exchange; a movement time calculation unit which calculates a fastest movement time from an acquired movement distance, and a speed at which causing the table to move fastest; a tool exchange time calculation unit which calculates a tool exchange time; a comparison unit which compares the tool exchange time calculated and the fastest movement time calculated; and a speed changing unit which changes the movement speed of the table, in a case of the fastest movement time being shorter than the tool exchange time, so that the movement time of the table becomes longer than the fastest movement time.

According to the present disclosure, it is possible to provide a control device and a recording medium encoded with a program which can optimize the movement speed of a table during tool exchange.

### BRIEF DESCRIPTION OF THE DRAWINGS

FIG. 1 is a schematic configuration diagram showing a machining system including a control device according to a first embodiment of the present disclosure;

FIG. 2 is a block diagram showing the configuration of the control device of the first embodiment;

FIG. 3 is a flowchart showing the flow of operations of the control device of the first embodiment;

FIG. 4 is a conceptual diagram showing an example of changing the speed by the control device of the first embodiment; and

FIG. 5 is a conceptual diagram showing an example of changing the speed by a control device of a second embodiment of the present disclosure.

### DETAILED DESCRIPTION OF THE INVENTION

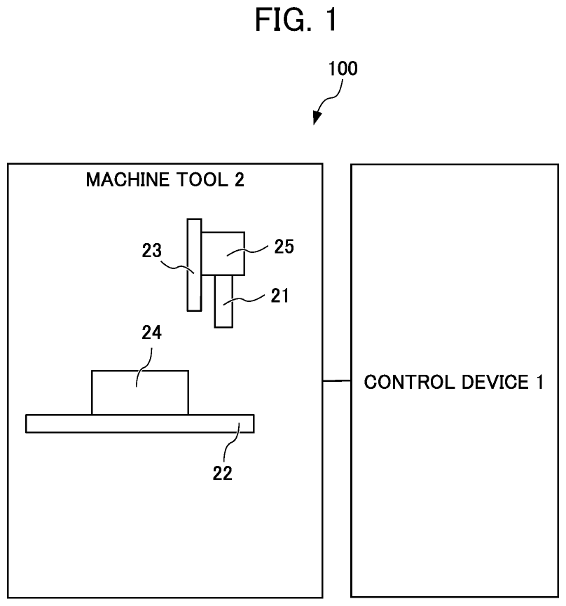

Hereinafter, a control device 1 and program according to each embodiment of the present disclosure will be explained with reference to FIGS. 1 to 5. First, before explaining the control device 1 in each embodiment, a summary of the relationship between the exchange of a tool 21 of a machine tool 2 controlled by the control device 1 and movement of a table 22 will be explained.

The machine tool 2 is included in a machining system 100, as shown in FIG. 1. The machine tool 2 machines a work piece 24, while exchanging a plurality of tools 21 retained in a magazine 23, according to the machining contents. In the exchange of the tools 21, the time is required to mount the tool 21 retained in the magazine 23 to the spindle 25, after removing the tool 21 mounted to a spindle 25 (hereinafter referred to as tool exchange time). It is possible to shorten the cycle time (machining time), by moving the table 22 (workpiece 24) in advance to the next machining position, during the tool exchange time. For example, in the case of moving the table 22, it is possible to position the table 22 at the destination in the shortest time, by moving each axis at the maximum speed according to the destination. On the other hand, in the case of the tool exchange time being longer than the shortest time, it is possible to suppress heat generation of a motor (not shown) running the spindle, by changing (adjusting) the movement time of the table 22. The control device 1 and program according to the following embodiment suppress heat generation of a motor, i.e. achieve optimization of the movement speed of the table 22, by changing the movement speed of the table 22.

### First Embodiment

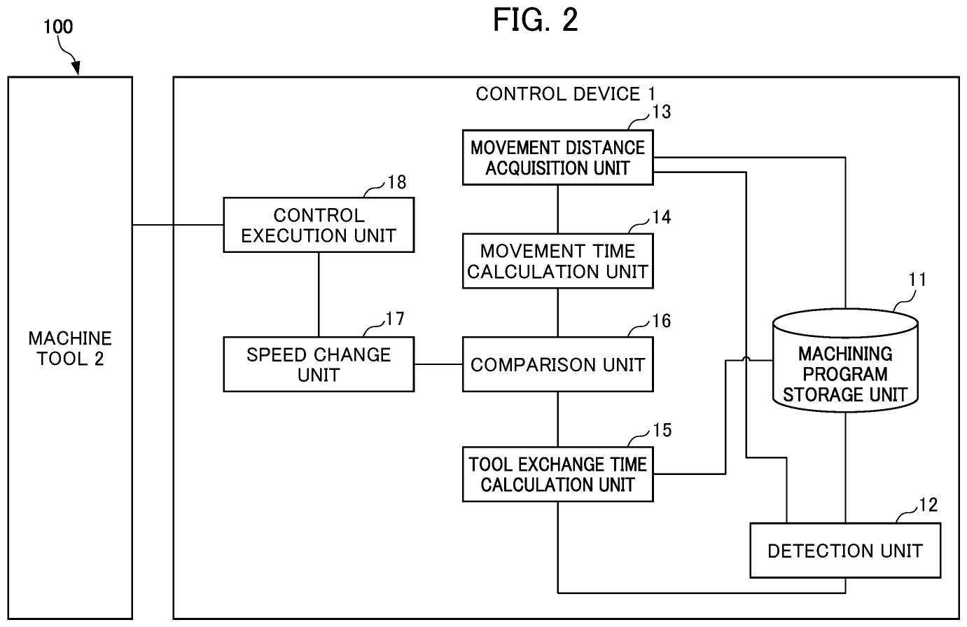

Next, the control device 1 and program according co the first embodiment of the present disclosure will be explained with reference to FIGS. 1 to 4. The control device 1 is included in a machining system 100, as shown in FIG. 1. The control device 1 is configured to be able to control a machine tool 2. In the present embodiment, the control device 1 controls the machine tool 2 so as to move the table 22 during exchange of the tools 21. The control device 1 includes: a machining program storage unit 11, a detection unit 12, a movement distance acquisition unit 13, a movement time calculation unit 14, a tool exchange time calculation unit 15, a comparison unit 16, a speed changing unit 17, and a control execution unit 18, as shown in FIG. 2.

The machining program storage unit 11 is a secondary storage medium such as a hard dish, for example. The machining program storage unit 11 stores a machining program indicating the movements of the tool 21 and table 22. In addition, the machining program storage unit 11 stores various setting information such as the movement speed of the axes of the table 22, or retaining positions of tools 21 in the magazine 23.

The detection unit 12, for example, is realized by a CPU operation. The detection unit 12 detects commands for conducting tool exchange and movement of the table 22 simultaneously, in relation to a machining program stored in the machining program storage unit 11. The detection unit 12 causes the movement distance acquisition unit 13 and tool exchange time calculation unit 15 to move according to the detection.

The movement distance acquisition unit 13 is realized by the CPU operation, for example. The movement distance acquisition unit 13 acquires the movement distance of the table 22 during tool exchange. The movement distance acquisition unit 13 acquires the movement distances of the X axis and Y axis from the start to the end of tool exchange, from the machining program storage unit 11, for example. In addition, the movement distance acquisition unit 13 acquires the highest speed of each of the X axis and Y axis, from the machining program storage unit 11.

The movement time calculation unit 14 is realized by a CPU operation, for example. The movement time calculation unit 14 calculates the fastest movement time, from the acquired movement distance, and the speed at which the table 22 is caused to move fastest. The movement time calculation unit 14, for example, calculates the fastest movement time, based on the movement distance, and the highest speed of each axis.

The tool exchange time calculation unit 15 is realized by a CPU operation, for example. The tool exchange time calculation unit 15 calculates the exchange time of the tools 21. The tool exchange time calculation unit 15, for example, acquires the retaining position of the tools 21 in the magazine 23, from the machining program as setting information. The tool exchange time calculation unit 15 calculates the tool exchange time based on the retaining position of the acquired tool 21.

The comparison unit 16 is realized by a CPU operation, for example. The comparison unit 16 compares the calculated tool exchange time with the calculated fastest movement time. More specifically, the comparison unit 16 compares whether the calculated tool exchange time is longer than the calculated fastest movement time.

The speed chancing unit 17 is realized by a CPU operation, for example. In the case of the fastest movement time being shorter than the tool exchange time, the speed changing unit 17 changes the movement speed of the table 22, so that the movement time of the table 22 is longer than the fastest movement time, with the tool exchange time being made as the limit. The speed changing unit 17, for example, recalculates the rapid-traverse time constant of the X axis and Y axis, and changes the movement time during tool exchange to be longer. The speed changing unit 17, for example, changes the movement speed of the table 22, so that the movement time becomes 95% relative to the tool exchange time.

The control execution unit 18 is realized by a CPU operation, for example. The control execution unit 18 causes the table 22 to actually move at the changed movement speed of the table 22. In addition, the control execution unit 18 causes the tool 21 to be exchanged in accordance with the machining program.

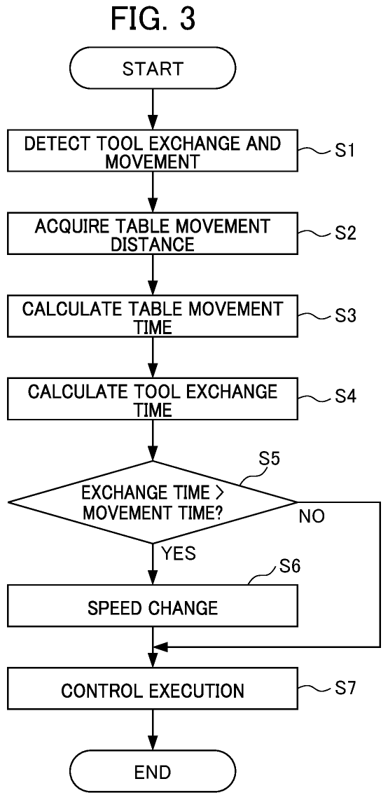

Next, operation of the control device 1 of the present embodiment will be explained using the flowchart of FIG. 3. First, the detection unit 12 detects a command for simultaneously conducting tool exchange and movement of the table 22, in relation to the machining program stored in the machining program storage unit 11 (Step S1). The detection unit 12 causes the movement distance acquisition unit 13 and tool exchange time calculation unit 15 to operate, when detecting the corresponding command.

Next, the movement distance acquisition unit 13 acquires the movement distance of the table 22 (Step S2). The movement distance acquisition unit 13, for example, acquires the movement distance of the table 22 included in the detected machining program.

Next, the movement time calculation unit 14 calculates the movement time from the movement distance of the table 22 and the fastest movement speed of each axis (Step S3). Next, the tool exchange time calculation unit 15 calculates the exchange time of the tool 21 (Step S4).

Next, the comparison unit 16 compares the tool exchange time with the movement time of the table 22 (Step S5). In the case of the tool exchange time being longer than the movement time of the table 22 (Step S5: YES), the processing advances to Step S6. On the other hand, in the case of the tool exchange time being shorter than the movement time of the table 22 (Step S5: NO), the processing advances to Step S7.

In Step S6, the speed changing unit 17 changes the movement speed of the table 22. The speed changing unit 17, for example, changes so as to make the movement speed of the table 22 longer, with the tool exchange time being made as a limit.

Next, in Step S7, the control execution unit 18 actually executes the exchange of tools 21 and the movement of the table 22. The processing according to the present flow thereby ends.

Next, the program of the present disclosure will be explained. Each configuration included in the control device 1 can be realized by way of hardware, software or a combination thereof. Herein, being realized by software means being realized by a computer reading and executing a program.

The program can be stored using various types of non-transitory computer readable media, and supplied to the computer. Non-transitory computer readable medium includes various types of tangible storage media. Examples of non-transitory computer readable media include magnetic recording media (e.g., flexible disk, magnetic tape, hard disk drive), magneto-optical recording media (e.g., magneto-optical disk), CD-ROM (Read Only Memory), CD-R, CD-R/W and semiconductor memory (e.g., mask ROM, PROM (programmable ROM), EPROM (Erasable PROM), flash ROM, RAM (random access memory)). In addition, the display program may be supplied to the computer by way of various types of transitory computer readable media. Examples of transitory computer readable media include electrical signals, optical signals and electromagnetic waves. Transitory computer readable media can supply programs to the computer via wired communication paths such as electric wires and optical fiber, or wireless communication paths.

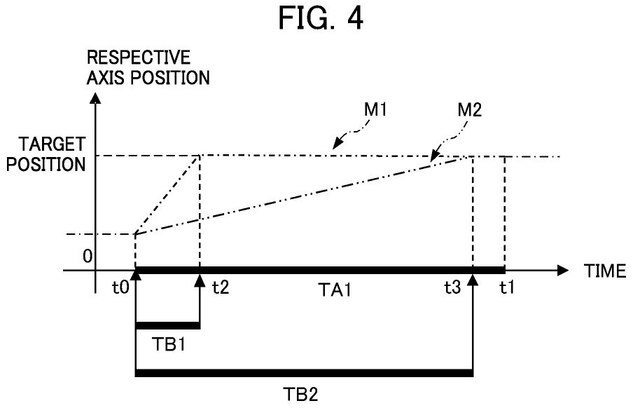

Next, Examples of the present embodiment will be explained with reference to FIG. 4. As shown in FIG. 4, the movement start time of the table 22 and the tool exchange start time are denoted as t0. Then, the exchange end time of the tool 21 is denoted as t1. In the case of moving the table 22 the fastest, the table 22 moves up to the target position, during the time from t0 to t2 (movement time TB1) (one-dot dashed line M1 in FIG. 4). In contrast, in the case of delaying the movement speed of the table 22 according to the tool exchange time, the table 22 moves to the target position (two-dot dashed line M2 in FIG. 4), during the time from t0 to t3 (movement time TB2). Herein, time t3 is later than time t2, and earlier than t1. In the exchange end time of the tool 21 (time t1), it is thereby possible to move the table 22 to the target position, and possible to slow the movement speed of the axis. It should be noted that it is ideal for the movement of the table 22 to be completed at the exchange end time t1 of the tool 21. Therefore, the time t3 at which the movement of the table 22 is completed is preferably set at a time close to time t1, while not being the same time as time t1. Compared to the case of being the same time, it is thereby possible to give a margin in the machining of the workpiece 24.

According to the control device 1 and program in the first embodiment above, the following effects are obtained. (1) The control device 1 which controls the machine tool 2 so as to make the table 22 move during exchange of the tools 21, includes: the movement distance acquisition unit 13 which acquires the movement distance of the table 22 during tool exchange; the movement time calculation unit 14 which calculates the fastest movement time from the acquired movement distance and the speed at which the table 22 is caused to move the fastest; the tool exchange tool calculation unit 15 which calculates the exchange time of the tool 21; the comparison unit 16 which compares the calculated tool exchange time with the calculated fastest movement time; and the speed changing unit 17 which changes the movement speed of the table 22, in a case of the fastest movement time being shorter than the tool exchange time, so that the movement time of the table 22 becomes longer than the fastest movement time, with the tool exchange time being made as a limit. In addition, a program causes a computer to function as the control device 1 which controls the machine tool so as to move the table 22 during exchange of the tools 21, the computer being caused to function as: the movement distance acquisition unit 13 which acquires the movement distance of the table 22 during tool exchange; the movement time calculation unit 14 which calculates the fastest movement time from the acquired movement distance and the speed at which the table 22 is caused to move the fastest; the tool exchange tool calculation unit 15 which calculates the exchange time of the tool 21; the comparison unit 16 which compares the calculated tool exchange time with the calculated fastest movement time; and the speed changing unit 17 which changes the movement speed of the table 22, in a case of the fastest movement time being shorter than the tool exchange time, so that the movement time of the table 22 becomes longer than the fastest movement time, with the tool exchange time being made as a limit. It is thereby possible to change the movement speed of the table 22 during the tool exchange. Therefore, it is possible to suppress heat generation of the axis moving the table 22. In addition, it is possible to suppress electrical consumption, and suppress operating costs. In other words, it is possible to optimize the movement speed of the table 22.

### Second Embodiment

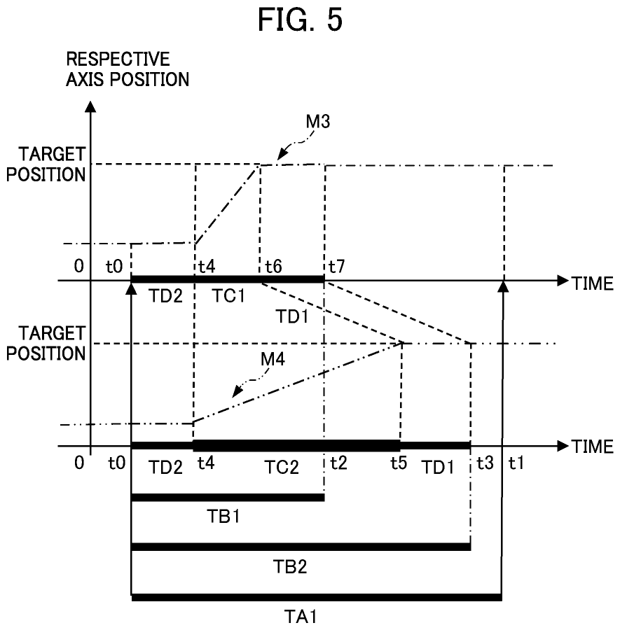

Next, a control device 1 and program according to a second embodiment of the present disclosure will be explained with reference to FIG. 5. Upon explanation of the second embodiment, the same reference symbols are assigned to constituent elements which are identical to the aforementioned embodiment, and explanations thereof are omitted or abbreviated. The control device 1 and program according to The second embodiment are made taking consideration of the movement time of a brake mechanism (clamping, unclamping operation) of the axis, in addition to the control device 1 and program in the first embodiment.

More specifically, the control device 1 and program according to the second embodiment differ from the first embodiment in that the movement time calculation unit 14 adds the clamping time and unclamping time of the table 22 to the fastest movement time to calculate the actual movement time. In addition, the control device 1 and program according to the second embodiment differ from the first embodiment, in that the speed changing unit 17 changes the movement speed of the table 22 in order to make the actual movement time of the table 22 longer than the fastest movement time, with the tool exchange time being made as a limit, in the case of the actual movement time being shorter than the tool exchange time.

Next, Examples of the control device 1 and program according to the second embodiment will be explained with reference to FIG. 5. As shown in FIG. 5, the movement start time of the table 22 and the tool exchange start time are denoted as t1. Then, the exchange end time of the tool 21 is denoted as t1. In the case of moving the table 22 at the fastest speed, the table 22 moves up to the target position from time t0 to time t7 (movement time TB1) (one-dot dashed line M3 in FIG. 5). At this time, the actual movement time TB1 is comprised of the unclamping time TD2 (end time t4), movement time TC1 (end time t6), and clamping time TD1 (end time t7).

In contrast, in the case of slowing the movement speed of the table 22 according to the tool exchange time, the table 22 moves to the target position (two-dot dashed line M4 in FIG. 5) from time t0 to time t3 (movement time TB2). At this time, the actual movement time TB2 is configured by the unclamping time TD2 (end time t4), movement time TC2 (end time t5), and clamping time TD1 (end time t3). Herein, time t3 is later than time t7, and earlier than time t1. At the exchange end time of the tool 21 (time t1), it is thereby possible to make the table 22 move to the target position, and slow the movement speed of the axis.

According to the control device 1 and program in the second embodiment above, the following effects are obtained. (3) The movement time calculation unit 14 adds the clamping time and unclamping time of the table 22 to the fastest movement time to calculate the actual movement speed. Even if being an axis having a brake mechanism, it is thereby possible to realize a change in speed. Therefore, it is possible to improve the versatility of the control device 1.

(4) The speed changing unit 17, in the case of the actual movement time being shorter than the tool exchange time, changes the movement speed of the table 22, so that the actual movement time of the table 22 becomes longer than the fastest movement time, with the tool exchange time being made as a limit. It is thereby possible to improve the versatility of the control device 1, by changing the actual speed.

Although the respective preferred embodiments of the control device and program of the present disclosure have been explained above, the present disclosure is not to be limited to the aforementioned embodiments, and modifications are possible as appropriate. For example, in the above embodiments, the speed changing unit 17 may store the changed movement speed of the table 22 as an item among the various settings in the machining program storage unit 11. The control execution unit 18 may be configured so as to control movement of the table 22, by reading a stored item, upon executing a machining program.

In addition, in the above embodiments, the speed changing unit 17 is not limited to a change in speed, and may be configured so as to change the acceleration of the axis. In addition, the speed changing unit 17 may be configured so as to change the movement speed of the table 22, by adopting the time constant of the speed by a sequence decided in advance.

In addition, in the above embodiments, the control device 1 is explained as being independent from the machine tool 2; however, it is not limited thereto. The control device 1 may be configured integrally with the machine tool 2.

### EXPLANATION OF REFERENCE NUMERALS

1 control device
2 machine tool
13 movement distance acquisition unit
14 movement time calculation unit
15 tool exchange time calculation unit
16 comparison unit
17 speed changing unit
21 tool
22 table

What is claimed is:

1. A control device which controls a machine tool so as to move a table during exchange of tools, the control device comprising:
a movement distance acquisition unit which acquires a movement distance of the table during tool exchange;
a movement time calculation unit which calculates a fastest movement time from an acquired movement distance, and a speed at which the table is caused to move fastest;
a tool exchange time calculation unit which calculates a tool exchange time;
a comparison unit which compares the tool exchange time calculated with the fastest movement time calculated; and
a speed changing unit which changes the movement speed of the table, in a case of the fastest movement time being shorter than the tool exchange time, so that the movement time of the table becomes longer than the fastest movement time.

2. The control device according to claim 1, wherein the movement time calculation unit adds a clamping time and an unclamping time of the table to the fastest movement time to calculate an actual movement time.

3. The control device according to claim 2, wherein the speed changing unit, in a case of the actual movement time being shorter than the tool exchange time, changes the movement speed of the table, so that the actual movement time of the table becomes longer than the fastest movement time, with the tool exchange time being made as a limit.

4. A recording medium encoded with a program which causes a computes to function as a control device that controls a machine tool so as to cause a table to move during exchange of tools,
the program causing the computer to function as:
a movement distance acquisition unit which acquires a movement distance of the table during tool exchange;
a movement time calculation unit which calculates a fastest movement time from as acquired movement distance, and a speed at which the table is caused to move fastest;
a tool exchange time calculation unit which calculates a tool exchange time;
a comparison unit which compares the tool exchange time calculated with the fastest movement time calculated; and
a speed changing unit which changes the movement speed of the table, in a case of the fastest movement time being shorter than the tool exchange time, so that the movement time of the table becomes longer than the fastest movement time.
